(19) United States
(12) Patent Application Publication
(10) Pub. No.: US 2016/0010623 A1
(43) Pub. Date: Jan. 14, 2016

(54) Modular wing-shaped tower self-erection for increased wind turbine hub height

(71) Applicant: Michael Zuteck, Clear Lake Shores, TX (US)

(72) Inventor: Michael Zuteck, Clear Lake Shores, TX (US)

(21) Appl. No.: 14/580,471

(22) Filed: Dec. 23, 2014

Related U.S. Application Data
(60) Provisional application No. 62/023,744, filed on Jul. 11, 2014.

(51) Int. Cl. F03D 1/00; B66C 23/18; E04H 12/34; E04H 12/00; F03D 11/04

(52) U.S. Cl. CPC F03D 1/005; E04H 12/00; F03D 11/04; E04H 12/344; E04H 12/345; B66C 23/185; F03D 1/001

(57) ABSTRACT

A wind turbine tower comprising a first forward leaning rotating tower having a leading edge and back edge where the first tower rotates on a lower bearing and an upper bearing and the upper bearing is supported by a second fixed lower tower that encloses a lower portion of the rotating tower. Also the forward leaning rotating tower comprises a leaning back edge supporting an attached climbing crane utilized in construction of the tower where the climbing crane is able to reach forward of the forward leaning rotating tower and second fixed lower tower, to raise segments of the forward leaning rotating tower, wind turbine nacelle, and wind turbine rotor. The rotating tower may also be support by guy wires attached to a mid-tower collar. The lifting power of the climbing crane can be supplied by a mobile ground winch. The climbing crane may also utilize a balanced boom.

### BACKGROUND OF DISCLOSURE

1. Field of Use

This disclosure pertains to power generating wind turbines utilizing a rotating tower with increased dimensions in the direction of the wind, compared to cross wind. The tower may be modular to facilitate transportation and construction. It may also utilize a fixed lower tower to retain at its top a rotating bearing that supports rotation of the rotating tower located within and extending above it.

2. Prior Art

Designs for power generating wind turbines are known in the art. Most require the construction of a stationary single shaft tower, frequently conical in design, that must withstand wind currents from all directions. Other towers comprise multi-leg structures. The rotor and nacelle usually rotate on top of the tower structure. A limited class of towers that rotate are known in the early art.

### BACKGROUND TO DISCLOSURE

The tower design subject of this disclosure seeks to increase annual energy production (AEP) by capturing generally increasing wind speed with height in the atmospheric boundary layer region near the earth's surface. Proximate to the earth's surface, friction, along with thermal and turbulent mixing effects, cause rapid changes in wind speed. These effects decrease with increased height.

Wind speed is often assumed to scale vertically using a power law with a wind shear parameter of α=1/7 at onshore sites. This simplified calculation yields about a 10% increase in wind speed going from a typical 80 m to a 150 m increased hub height. Given the cubic relationship between wind speed and energy in the wind flow, this 10% speed increase adds about 1/3 more wind turbine output below rated power, and allows the turbine to reach its full rating in 10% less wind. The effect is to both produce more energy overall, and to spread the energy more evenly over time, both of which have economic value to the wind generating facility.

In the early years of commercial wind turbine development, tower heights were low by today's standards, and relatively small rotors were used for a given turbine rating, resulting in rotor disk loadings often in the range of 400-500 watts/meter̂2, and capacity factors (the average of rated power achieved) in the 20%+range. The taller towers and much larger rotors used now result in disk loadings in the 200-300 watt/m̂2 range, and capacity factors often over 40%.

High capacity factors make better use of the transmission lines, and the wind facility is online more of the time, making it a more statistically reliable source from the utility perspective.

The introduction of even taller towers would further enhance this long term trend, by reaching the stronger, steadier, more reliable winds further above the ground. Particularly at lower speed wind sites, the amount of additional energy revenue can be large, often a ⅓ to even ⅔ increase depending on site conditions.

The key difficulty in exploiting favorable winds higher aloft is that conventional tower weight and cost scale poorly with increasing height, and the increase in tower cost can offset the additional revenue. The wing-shaped rotating tower subject of U.S. Pat. Nos. 7,891,939 B1 & 8,061,964 B2 which are incorporated by reference in their entirety, reduces the cost burden of additional height. This is achieved through the tower rotation that aligns its primary strength with the thrust plane, thereby consuming less material by providing increased dimensions in that plane, while also reducing the need to carry loads from other directions.

Another difficulty with exceptionally tail towers of 150 m or more, is that there are few cranes large enough to lift the turbine and rotor onto such a tower, they are very expensive, and are so large they cannot reach all desirable wind sites. To reduce this aspect of the tall tower cost, the rotating wing tower itself becomes the crane during erection, via a climbing crane that uses the partially completed rotating tower to build itself to full height, then lift the turbine nacelle and rotor to the top once completed. This addresses a major cost element without which tall towers are unlikely to achieve widespread market significance.

### SUMMARY OF DISCLOSURE

The goal of this patent is allow cost effective construction of wind turbine towers to up to and beyond 150 m (500 ft), while also mitigating logistic, transportation, and installation constraints. The described invention is based on a patented, lightweight, rotating, wing-shaped tall tower, supported by a fixed lower tower. The invention discloses a climbing crane with balanced boom that allows the partially completed rotating tower to be the crane structure used in its own completion, and for lifting the wind turbine nacelle and rotor to the top once the tower is complete. The method for using the climbing crane to erect the tower is also disclosed.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates a side view of a fixed lower tower and the tilting up of a portion of the forward leaning rotating tower into position on a bottom bearing and an mid-tower bearing.

FIG. 2 illustrates a side view of the rotating tower positioned on the lower bearing and mid-tower bearing, and tilting up the climbing crane toward its position on the rotating tower back edge.

FIG. 3 illustrates the climbing crane positioned on the back edge of the rotating tower, and using its balanced boom for hoisting a further rotating tower section into place atop the completed portion of the rotating tower.

FIG. 4 illustrates using the climbing crane near the tower top, with the balanced boom hoisting a turbine nacelle.

FIG. 5 illustrates the climbing crane hoisting the turbine rotor to the hub.

FIG. 6 illustrates the completed tower with the climbing crane attachment components left in position of the back edge of the rotating tower. Also illustrated is the enclosed fixed lower tower.

FIG. 7 is a cross sectional view of the rotating tower section illustrating the leading edge and the trailing edge.

### DETAILED DESCRIPTION OF DISCLOSURE

It will be appreciated that not all embodiments of the invention can be disclosed within the scope of this document and that additional embodiments of the invention will become apparent to persons skilled in the technology after reading this disclosure. These additional embodiments are claimed within the scope of this invention.

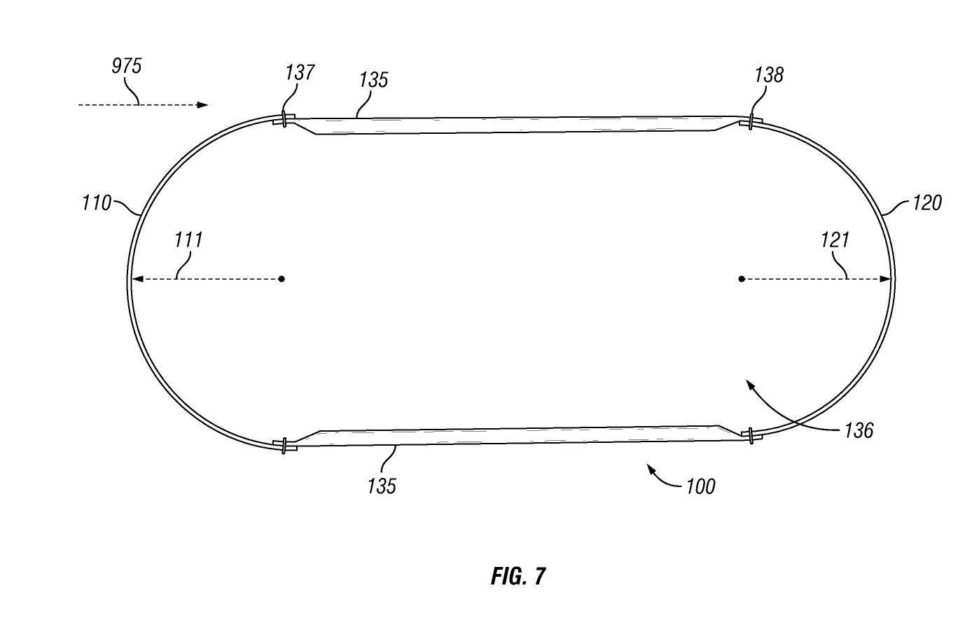

Referencing FIG. 7, the rotating wing-shaped tower 100 can be oriented with the wind (shown by vector arrow 975), which allows less material to carry a given bending moment, and reduced aerodynamic drag, compared with a conventional round tower, which must accept turbine and direct wind loading from any direction. The wing portion is comprised of structural leading 110 and trailing edges 120 that provide the main load paths, with joining panels 135 between the edges. The joining panels 137, 138 can be mechanically fastened to the leading edge 110 and trailing edge 120. The interior of the wing-shaped tower 136 can be empty. The separation of the edges tapers to follow the thrust bending moment on the tower. The half circle leading and trailing edges are much further apart than for a circular shape, so strength in the fore-aft direction is increased greatly, roughly linear with centroid separation, while stiffness increases even faster, going nearer as the square. This basic improvement in section geometry is what allows a given amount of material to reach higher into the airflow than is possible with conventional round tower construction. The leading and trailing edges need not be circles, and will be tailored for aerodynamic and structural optimization—the basic mechanism of increased efficiency remains effective. As will be described in greater detail herein, the trailing edge (back edge) can be modified to contain components allowing the attachment and movement of a climbing crane. It will be further appreciated that the back edge above the mid-tower bearing is at a less vertical angle than the leading edge (front edge) thereby facilitating the operation of the climbing crane. As used herein, front edge refers to the edge facing the components to be lifted while back edge refers to the edge facing away from the components to be lifted.

The tapering shape of the tower structure follows the primary thrust moment distribution, reducing the need to taper material thickness, and efficiently transferring load to the foundation via the conical tower base (fixed lower tower), The tapering tower width allows relatively uniform stress in the main structural edges so their material is loaded efficiently, and the side panels need carry only modest amounts of shear and bending loads. The material properties and shape can be selected based upon the rotating tower maintaining a relatively constant orientation with the wind.

Only the conical lower portion (fixed lower tower), either steel or reinforced concrete, need take loads from all directions down into the foundation. A large bearing at the top of the fixed conical section only transfers horizontal forces between the tower sections, not the entire local bending moment, providing a natural place to advantageously change tower material and structural type to save upper tower weight and cost. As described further herein, the height of the fixed conical tower bearing component is at the location of the widest portion of the rotating tower structure. In another embodiment, cables could support the upper bearing, as disclosed in the US patents cited herein.

In extreme wind conditions the tower may be allowed to self-feather causing the leading edge to become the trailing edge. The ability to choose the thickness, shape, and local radius of curvature of the leading edge part enhances the buckling stability of the leading edge while minimizing its weight and cost, i.e., maximizes structural efficiency. The ability to tailor the shape of this part could have a substantial impact on its weight, as its buckling stability may be a design driver for high wind survivability.

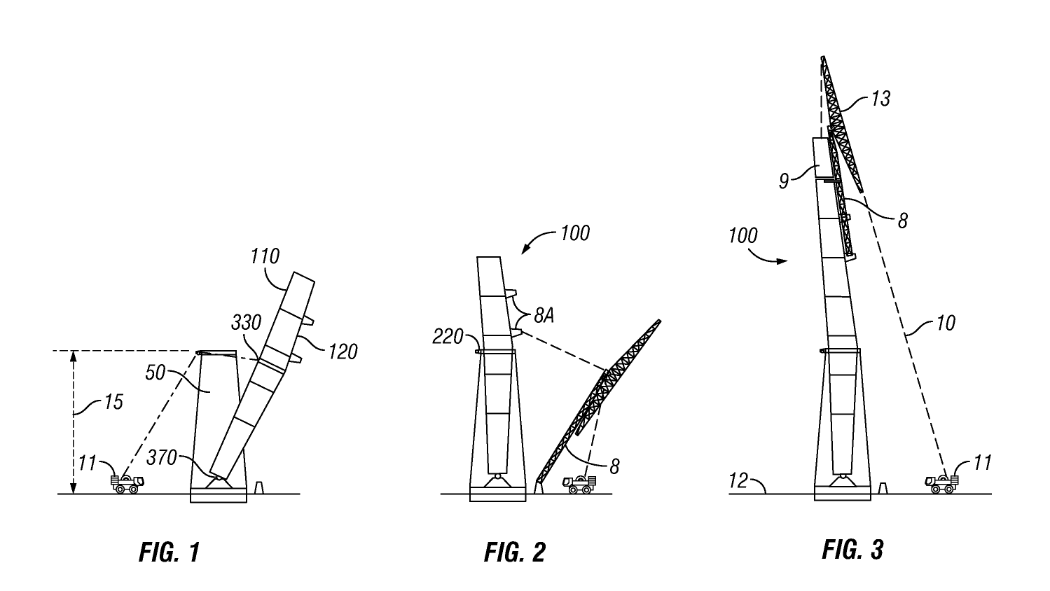

All components may be modular and shipped within existing wind turbine trucking and lifting constraints. The fixed portion can be installed with a conventional crane and can support tilting up a wing portion. The forward-leaning top of the wing tower can then be used to hoist upper tower sections to efficiently achieve very tall tower heights, and to provide the nacelle and rotor lift after the tower is assembled to full height. The description of the construction process is described below with reference to the FIGS. 1 through 6.

FIG. 1 illustrates an exposed interior side view of the fixed lower tower 50. Also illustrated is the leading edge (front edge) 110 and the trailing edge (back edge) 120 of the rotating tower 100. The rotating tower is shown installed on the lower bearing 370, and being tilted up from its mid point 330 (mid-tower collar). The rotating tower extends from a temporary open slot in the fixed tower structure. The mid point is where the separation between the leading and trailing edge is the greatest, and the tower is strongest. The height of the mid point is shown by vector arrow 15. The height of the midpoint may be the same as the height of the fixed lower tower wherein the bearing loads are taken into the strongest place on the tower. Also shown is the mobile ground winch 11, that tilts up the tower.

FIG. 2 illustrates the completed installation of the rotating tower 100 on to the lower bearing and the mid-tower bearing 220. The function and operation of the lower bearing and mid-tower bearing in relation to the rotating tower is more fully described in U.S. Pat. Nos. 7,891,939 & 8,061,964 . FIG. 2 also shows the climbing crane 8 being tilted toward initial engagement with the attachment modules 8A, from which position it would be hoisted to working height to begin its climb.

FIG. 3 illustrates the operation of the climbing crane 8 positioned on the back edge of the rotating forward leaning tower 100. The operation of the components used in the attachment of the climbing crane is described below. Also illustrated is the balanced climbing crane boom. An upper tower section 9 is illustrated suspended from a cable 10 in communication with the boom 13 and controlled by a ground winch 11. The tower segment is raised from the ground level 12 and hoisted into position on the rotating forward leaning tower. This process is continued sequentially until the tower reaches its full height. It will be appreciated that this disclosure teaches towers constructed up to and over 500 feet in height. (See vector arrow 14 illustrated in FIG. 6.) This is higher than the lifting capacity of most existing cranes. This is achieved by combination of the modular tower construction, the positioning and movement of the climbing crane 8 with a balanced boom 13, coordinated with operation of a mobile ground winch 11.

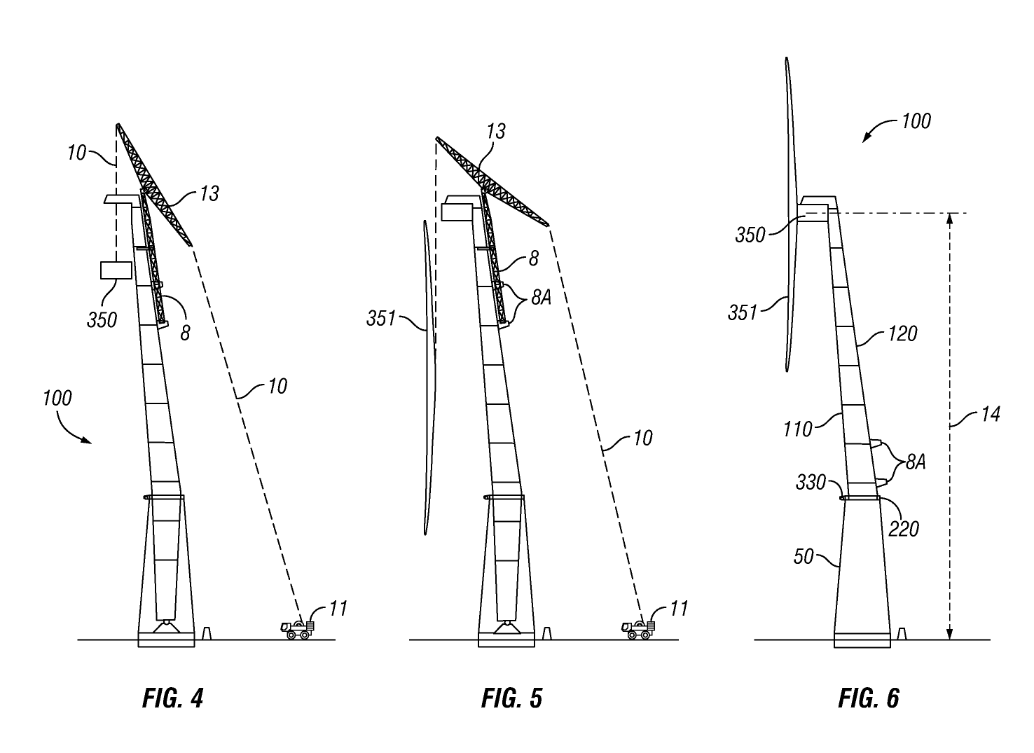

FIG. 4 illustrates the tower 100 at its completed height. The climbing crane is elevated to its greatest height. The nacelle 350 is shown being hoisted into position at the top of the rotating forward leaning tower. As will be explained below, the nacelle is hoisted in close proximity to the front edge of the tower.

FIG. 5 illustrates the hoisting of the turbine rotor 351 to the top of the tower. Also illustrated are the attachment modules 8A for the climbing crane 8 and the crane boom 13. FIG. 6 illustrates the completed tower. The tower 100 comprises the enclosed fixed lower tower 50, the lower bearing (not shown), mid tower collar 330 and mid-tower bearing 220, the trailing edge 120 with attachment modules 8A, leading edge 110, rotor 351 and nacelle 350. The tower height is represented by vector arrow 14. It will be appreciated that the lower portion of the rotating tower, i.e., below the mid-tower bearing, rotates within the structural exterior (load bearing) forming the fixed lower tower.

With reference to FIG. 1, the natural provision of a strong location part way up the tower merges well with erection using a tilt-up step. Because the tilt-up loads are applied where the leading to trailing edge separation is greatest, the amount of material needed in the structural edges is much reduced, and feasible tilt-up size compared with conventional towers is greatly increased. This, combined with the climbing crane, improves the economics and feasibility of increased tower height. The amount of tower to tilt up vs build incrementally can be dictated by the economics of site and transportation logistics.

The drag of a circular tower is more than five times the drag created by an aerodynamically streamlined shape of similar crosswind dimensions. Circular cylinders create substantial drag, due to large-scale disruption of fluid flow. The drag coefficient (Cd) for a large diameter circular tower in extreme wind conditions is approximately 0.7, and can be well in excess of 1.0 over a large range of operating Reynolds numbers. Research conducted on elliptical shapes similar in form to the wing shaped tower show that a Cd of 0.14 is attainable for typical tower sections, thereby reducing direct aerodynamic tower drag loads during extreme winds by about a factor of 5.

The rotating tower can be constructed to allow the leading edge to lean into the windward direction, as shown in FIG. 6. This increases the distance between the tower leading edge and the plane of rotation of the turbine blades. This minimizes potential for damage to the turbine blades by striking the tower, and allows for more blade flex during design.

Forward lean also decreases the moment distribution from rotor thrust that must be carried by the tower and its foundation, the mass upwind of the tower rotation axis providing a moment which counteracts some of the thrust induced bending moment normally carried by tower fore-aft mechanical strength.

The tower design subject of this disclosure incorporates a rotating tower with the capability to hoist the nacelle and rotor to hub heights that are well beyond current limits. A recent NREL report (Cotrell, J., Stehly. T., Johnson, J., Roberts, J. O., Parker, Z., Scott. G., and Heimiller, D., “Analysis of Transportation and Logistics Challenges Affecting the Deployment of Larger Wind Turbines: Summary of Results,” NREL/TP-5000-61063, January 2014 noted that nacelle hoisting is one of the most significant challenges for tower heights over 140 m. The nacelle weight for the 3.0 MW baseline turbine is 67 metric tonnes and it must be lifted to the full hub height. This requires a 1,250 to 1,600 tonnes crawler crane to assemble the wind turbine generator (WTG).

There are three key aspects to the tilt-up, incremental build, and hoist approach as illustrated schematically in FIGS. 1 through 5.
1. A fixed structural base tower that supports the wing tower tilting and build.
2. A wing-shaped, tilt-up tower using a hybrid of high strength leading and trailing edges with lightweight side panels. The amount of tilt up versus incremental build will be determined by site conditions, economics, and the height goal.
3. A forward lean on the wing tower similar to tall crane booms that aids the nacelle and rotor to be lifted into position after wing tower build is completed.

Feasibility

The fixed lower tower can be constructed using segmented steel or concrete construction as is seen in existing hybrid tower designs. An extension beyond current practice is leaving out one or more segments to tilt up the lower part of the rotating tower. Note that the size of the tilt up portion is to be chosen for best overall tower and erection costs—it can be anything from zero to full height as best benefits cost at given sites. It is possible to build the lower part of the rotating tower incrementally within the fixed portion. Using an incremental build for the lower rotating tower assures that the departure point for the upper tower build via the climbing crane can be achieved. In some rough terrain sites, this may be the best option, possibly the only option, available if or as needed.

Exploiting the forward lean of the tower allows a relatively simple and modest size climber crane to move up the tower in steps, installing successive upper tower segments as it proceeds. A characteristic of the tapering design of the upper tower is that the leading edge/trailing edge pieces, illustrated in FIG. 7, that carry the major loads can be constant shape and thickness, which aids both mating the climber to the tower at different heights, and keeping its lift weight requirement more nearly constant with height than conventional tower designs. It will be appreciated that the back edge can be fabricated with elements (not shown) that allow attachment and movement of the climbing crane. These elements can be permanent fixtures of the back edge. It is anticipated that the length of the segments can be chosen to facilitate the climber-crane design as well as shipping logistics. In effect, the tower itself becomes the boom of an ever taller crane as work progresses. There may not be any other way to achieve breakthrough heights, since some form of crane is needed to reach above the tower top to lift the nacelle and rotor. Costs for exceptionally tall cranes rise very fast, and they are not available to service all locations. The costs that go into building this tower remain with the turbine; there are no large crane mobilization or teardown costs.

The climbing crane is illustrated in FIGS. 3-5. It comprises a climbing crane frame, attachment modules, and balanced boom. The frame is a truss structure and moves parallel to the slope of the tower back edge. The climbing crane includes attachment modules for attachment of the frame to the tower back edge. The frame has at its tip a pivoting boom that provides forward reach for lifting the loads.

Back edge elements engaged by the climbing crane attachment modules could be a captive rail(s) as used on roller coasters, holes into which mechanical cogs are inserted, complementary geared wheels and rails, or even bands that reach around the tower and secure the crane from falling away, with wheels to roll along the tower edge.

The height adjustment of the climbing crane could be achieved by one or more hydraulic lifts within the attachment modules. The hydraulic lift(s) contains components such as over center grip pads that interface with complementary fitting components such as a rail(s) on the back edge. The hydraulic lifts propel the climbing crane to the next higher level on the back edge, while multiple redundant over-center grip pads may provide safe retention by requiring active release to safeguard against accidental drop, similar to personal safety harness climbing equipment.

In another embodiment, the climbing crane uses cogs as on cogged railways, with the attachment modules employing cog wheels interfacing with a cog rail permanently affixed to the tower back edge. In another embodiment the climbing crane attachment comprises a geared or toothed wheel that interfaces with geared or toothed rail(s) permanently attached to the tower back edge

It will be appreciated that additional fitting components of the back edge may be located at engineered strong points. For example, there may be fitting components at the junctures of tower segments. It will be appreciated that there is substantial material reinforcement at these junctures due to overlap between the tower segments, so they are favored locations for reacting the elevated loads that occur during component lifting.

The cog rail system and geared rail system are examples of permanent back edge elements. The components may include one or more guide rails. Similar rails could provide a griping surface for one or more additional fail safe components on the climbing crane frame.

The above described cog wheel, geared or toothed wheel, and hydraulic lift are examples of climbing crane attachment module elevation devices. Other examples are clamping pads similar to brake system calipers that grip and release in sequentially higher (or lower) positions, or a winch and cable or chain that lifts or lowers the climbing crane to a new height. Many other mechanisms that can achieve the same functions are known, and are claimed herein as ways to adjust the climbing crane height while securing it to the rotating tower back edge.

Another component of the attachment modules are contact pads that are shaped to complement the surface of the tower back edge. The pads help transfer the crane load into the tower. They may be adjustable in shape if needed to follow changes in tower back edge shape.

The climbing crane frame also includes a balanced pivoting boom comprising a truss structure at the tip of the climber crane frame that pivots to control the forward reach of the lift hook. This truss may be strengthened or built lighter using a kingpost and cable arrangement about it to increase the geometry carrying the beam bending loads.

The climbing crane used in conjunction with the rotating forward leaning tower is a very novel and useful development. There is, however, an important structural limitation. It is essential that the climbing crane not impose loads on the partially complete tower during erection, and on the completed tower during turbine nacelle and rotor lift, that add significant cost and weight penalties to the tower as it would be designed in the absence of the climber crane. In its normal function (absent the role of the climbing crane) the tower carries the wind turbine thrust induced loads to the ground. The rotating tower front and back edges are therefore constructed to carry the large structural loads in the vertical direction. The vertical component of the climbing crane loads is small relative to tower working and extreme loads, and will not require further strengthening.

The same is not true for bending moment induced forces applied perpendicularly into the tower back edge by the climbing crane. In normal operation of the rotating forward leaning tower, (even in extreme winds), the local loads on the tower edges are small compared to those that can be created from the overhanging moment of the lifting operations. Therefore net loads must be kept as close to the tower, and as well aligned with its length axis, as possible. As an example, if the load being lifted were 50 tons, and the forward reach were three times the climbing crane attachment module separation, then the climbing crane would have to apply 150 tons toward and away from the tower back edge at its two primary attachment points. This is well beyond the capability of an unmodified rotating tower, and would impose serious additional cost and weight penalties.

Given the above, it is essential that the climbing crane not carry loads into its tower attachments as a conventional crane would do—it is acceptable to carry the vertical loads into the tower back edge, but the loads perpendicular to it must be largely eliminated. This requirement is met by the introduction of a balanced pivoting boom, which by its nature cannot communicate large moments into the climbing crane frame, nor the attachment modules which transfer its loads into the rotating tower back edge.

It should be noted that the pivoting boom does not have to be perfectly balanced to achieve its goals, as some level of perpendicular loads can be transferred toward or away from the tower back edge without modification. For engineering reasons, it may be advantageous to bias the boom one way or the other, for instance to distribute load into the attachment modules more evenly, or to preload the boom angle control in one direction, for instance if a cable and winch were used for this purpose. Balanced as used in this boom definition means near enough to equal moments to each side of the pivot that the tower need not be reinforced to handle the climber crane imposed loads. For a 1:1 cable system, a difference of 5%, 10%, or even 20% in boom arm lengths is thereby consistent with the invention. Note that the art of multiple cable purchase would allow a half length boom on one side of the pivot if a 2:1 cable purchase were provided, and balance would still be achieved against a 1:1 cable purchase on the other side. There are too many multiple purchase possibilities to enumerate, all of which are claimed within the scope of the invention, provided they result in the properly constrained moment balance at the boom pivot as described above. For clarity, the ensuing discussion will be framed in terms of a cable system with near equal booms and the same purchase at each end.

In order to provide the pivoting beam balance described above, the primary load lifting winch can not be on the climbing crane—it must be an independent ground winch vehicle that applies the same downward force to the back arm of the boom as lifting the load does to the front arm. This vehicle must be large enough to supply the required lifting cable tension without itself being lifted off the ground, whereby it must weigh substantially more than the largest load to be lifted, so that needed forces to resist being slid toward the tower base can be reliably provided. Given the size of large wind turbine components, a modified tracked vehicle similar in size to a Caterpillar D9 earthmover, with additional mass added, would be needed for a 1:1 lift system. If used offshore, an erection ship would provide the function of the winch vehicle. In order to reduce the size of the ground winch vehicle, provide flexibility of operation, smaller cable loads, or other advantages, it is possible to use two ground vehicles, both of which may carry winches, or one of which may serve to dead end a 2:1 lifting cable, while the other carries the active winch. In this case, double sheaves would be used at each end of the pivoting boom, and a 2:1 sheave would be used at the primary lifting hook. Many other variations are possible within the usual art of multiple purchase cable systems, and all of these are included within the scope of the disclosed invention.

A consequence of the balanced nature of the pivoting beam is that it takes little force or energy to change its angle, even under load. In the idealized world of zero friction and perfect balance, it would take no force at all, and in that case, conservation of energy dictates that load height should be completely unaffected by changes in boom angle. Of course in the real world there is friction to overcome, balance isn't perfect, and cable vibrations, wind or other sources may impose transient loads. A powered motor system on the climbing crane is expected to provide the forces needed to overcome these loads. This could be done with a large gear on the balanced boom, and worm or pinion drives on the climbing crane frame, similar to how wind turbine yaw drives work. Alternatively, a winch and cable could be used, if the boom loads were biased so it always tries to pivot in one direction. This could also be done using additional independently controlled cables from the ground winch vehicle. Given the tower heights for which the climber crane is intended, this last is not seen as a preferred embodiment, but is claimed within the scope of the patent.

It remains the case that lift height would be largely independent of pivoting boom angle, and this could be an advantage for the final phase of the lifts where wherein the tower sections or turbine components are placed upon the tower structure. At that time, the pivoting boom will be at its nearest to vertical to provide minimum reach and maximum height, so it is in this condition where having the best decoupling of boom angle from load height is most valuable, allowing the crane operator to move the load toward or away from the tower precisely, without having to make multiple small adjustments to compensate changes in height. Note also that the distance from the climbing crane support points to the load is very much shorter than the 500′+ reach to tower top for a ground crane, and because the climbing crane and tower move together rather than independently, the precision and speed of load placement will be aided by that feature of the invention as well.

To have complete decoupling of pivoting boom angle from load height, the angle to the vertical of the cable to the winch vehicle must be twice the angle to the vertical of the tower back edge. The balance of forces is most easily seen when the lift cable is not deflected at the aft boom sheave, in which case the bisector of the angle of the cable around the front arm sheave is parallel to the tower back edge, producing a force parallel to it as desired to help minimize loads from the climbing crane into the tower back edge.

As with the balance of the pivoting boom arm moments, it is understood that there may be engineering advantages to having a few degrees of bias to help distribute climbing crane loads into the tower optimally, or operationally to aid the precise placement of the lifted components. These variations from ideal bisection for engineering reasons are included within the scope of the disclosed invention. Also included is the option to move the winch vehicle between lifts to maintain the best angle when the pivoting boom is at top of reach, or even to adjust position by crawling the winch vehicle during the lift if there were special circumstance to warrant this additional adjustment.

Part of practical crane operation utilizing the rotating forward leaning tower is the provision of lateral lift line adjustment, that is, perpendicular to the direction toward or away from the tower, this latter provided by adjustments in the pivoting boom angle. Near ground level, the rotational yaw ability of the rotating tower combined with its forward lean can be used to provide a degree of lateral adjustment of the lift line for picking loads from the ground. This would not be used for large lateral movements, as that would impose additional loads on the climber crane, attachment modules, and tower back edge—a small ground crane would be used to place loads in the designated lift zone, and the limited lateral adjustment would be to aid attaching the load to the lift hook, and limiting adverse loads or motions in the initial lift free of ground contact.

At top of reach, yaw of the rotating tower is ineffective for lateral adjustment because both tower and crane move together, so instead small side to side adjustments of the climbing crane frame relative to its attachment modules, or rotation of the frame end pivot attachment to the boom, would be used to provide the limited side-to-side adjustment needed for load placement. Other mechanisms to achieve these same frame to boom sideward angle adjustments are included within the scope of the present invention.

When the climbing crane is to adjust its vertical position on the back edge of the rotating tower, this would be done with no lift load. The center of gravity of the climbing crane is not far removed from the trailing edge, so moments due to gravity force offset would be modest, and the gravity force vector would be nearly in alignment with the tower trailing edge. This imposes minimal requirements on the attachment modules and lifting mechanism during vertical crane position adjustment. The back edge elements engaged by the attachment modules could be captive rails as used on roller coasters, holes into which mechanical cogs are inserted, or even bands that reach around the tower and secure the crane from falling away, with wheels to roll along the tower edge. The height adjustment could be achieved by cogs as on cogged railways, clamping pads similar to brake system calipers that grip and release in sequentially higher (or lower) positions, or a winch and cable that lifts the climbing crane to its new height. Many other mechanisms that can achieve the same functions are known, and are claimed herein as ways to adjust the climbing crane height while securing it to the rotating tower back edge.

Lifting would be done only once the climbing crane is in position at a chosen location. A preferred choice would be where the attachment modules are at the joints between tower sections, since the overlap creates a thicker, stiffer, and stronger zone there. At this location, secure retention would be engaged, such as pins inserted into holes in the tower or rails, or mechanical clamping to the rails that requires powered release. Many similar safety requirements exist for cables cars, ski lifts, as well as large crane erection, and would be applied to make the climbing crane movement and retention both safe and efficient. The use of such a system is claimed within the scope of this invention

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

Claims

1. A wind turbine tower comprising a first forward leaning rotating tower wherein the first tower rotates on a lower bearing and an upper bearing and the upper bearing is supported by a second fixed lower tower that encloses a lower portion of the rotating tower.

2. The wind turbine tower of claim 1 wherein the first forward leaning rotating tower comprises a leaning back edge supporting an attached climbing crane wherein the climbing crane is able to reach forward of the first forward leaning rotating tower and second fixed lower tower, to raise segments of the first forward leaning rotating tower, wind turbine nacelle, and wind turbine rotor.

3. The wind turbine tower of claim 2 wherein the back edge of the rotating tower may include elements that allow tower back edge climbing crane attachment modules to be secured to the back edge of the first forward leaning rotating tower.

4. The wind turbine tower of claim 3 wherein climbing crane attachment modules may employ a mechanism to lift the climbing crane up the back edge of the first forward leaning tower, hold the climbing crane in position, or lower the climbing crane down the tower.

5. The wind turbine tower of claim 4 further comprising one or more back edge elements, that may remain with the completed tower, for later use in case wind turbine repair requires return of crane capability

6. The wind turbine tower of claim 3 further comprising the climbing crane attachment modules may include contact pads wherein the contact pads
a) shaped to match the back edge surface,
b) shaped to spread the load of the climbing crane onto the back edge surface, and
c) structured to support the back edge against load induced deformation during lifting.

7. The wind turbine tower climbing crane of claim 2 further comprising a balanced pivoting boom proximate to a tip of a climbing crane frame, wherein this boom controls how far forward a line of lift extends.

8. The pivoting boom of claim 7, comprising lifting cable turning sheaves at each end, that pass a first main lifting cable from a ground based winch vehicle positioned to a back side of the second fixed lower tower up to and, across the pivoting boom, to the lift zone on the front side.

9. The ground based winch vehicle of claim 8, wherein the winch vehicle is positioned so the first main lifting cable approximately doubles the angle to the vertical of the back side of the rotating tower, with the pivoting beam at top of reach.

10. The pivoting boom of claim 8, wherein the height of the load remains unchanged when the boom to climbing crane frame angle is adjusted.

11. The ground based winch vehicle of claim 9 moveably positioned toward or away from the rotating tower between (or during) lifts to maintain double the cable angle to the vertical of the back side of the rotating tower.

12. The pivoting boom of claim 8, wherein the angle of the pivoting boom to the climbing crane frame may be controlled by a powered motor system on the climbing crane, that need not react to pivot rotational forces arising from a change of lifted load height with boom angle.

13. The climbing crane of claim 3, wherein small lateral adjustment of the climbing crane frame relative to the climbing crane attachment modules may be provided to allow lateral adjustment of a lifting hook near the top of the lifting hook's reach.

14. A rotating wind turbine tower comprising the rotating wind turbine tower supported by a plurality of guy wires anchored in a ground surface wherein the cables are attached a mid-tower collar containing a bearing component in communication with the rotating wind turbine tower.

15. A method of constructing a wind turbine tower comprising building a first forward leaning rotating tower and a second fixed lower tower with a temporary open slot within the second fixed lower tower to enable part or all of the first rotating tower to be tilted up and attached to a lower bearing and an upper bearing wherein the upper bearing is supported by the second fixed lower tower.

16. The method of claim 15 further comprising constructing the first rotating tower using tower segments, incrementally building the tower upward by adding the tower segments while in the vertical orientation, either from the ground level, or building upon a lower portion that is first tilted up.

17. The method of claim 16 further comprising tilting the climbing crane into a parallel position against a leaning back edge of a first forward leaning rotating tower to engage the climbing crane to attachment modules on the leaning back edge that secure the climbing crane for moving up and down the first forward leaning rotating tower.

18. The method of claim 16 comprising the steps of moving the climbing crane along the first forward leaning rotating tower and positioning the climbing crane at a support position at joints or other preferred strong locations of the tower for lifting of loads.

19. The method of claim 17, comprising the steps of activating a yaw motor and turning the rotating tower to provide lateral positioning of the lifting hook near ground level.

20. The method of adjusting the forward reach of the wind turbine tower climbing crane comprising activating mechanism on the climbing crane that controls the pivoting boom angle to the frame.

21. The method of claim 20 further comprising activating a low power mechanism to move the climbing crane in a lateral direction relative to the attachment modules to laterally move the lifting hook near top of reach.
